(19) United States
(12) Patent Application Publication
(10) Pub. No.: US 2026/0061314 A1
(43) Pub. Date: Mar. 5, 2026

(54) SYSTEMS AND METHODS FOR INTERACTING WITH A VIRTUAL ENVIRONMENT

(71) Applicant: Activision Publishing, Inc., Santa Monica, CA (US)

(72) Inventor: Matthew Kyle Scronce, Marina Del Rey, CA (US)

(73) Assignee: Activision Publishing, Inc., Santa Monica, CA (US)

(21) Appl. No.: 19/213,043

(22) Filed: May 20, 2025

Related U.S. Application Data
(60) Provisional application No. 63/687,614, filed on Aug. 27, 2024.

(51) Int. Cl. A63F 13/525; G06T 13/40; G06T 19/20

(52) U.S. Cl. CPC A63F 13/525; G06T 13/40; G06T 19/20; G06T 2219/2004; G06T 2219/2016

(57) ABSTRACT

A method may include, at a computing device: establishing a virtual camera at a first location relative to an avatar model of the virtual character, wherein the virtual camera has a camera orientation and the avatar model has a model orientation, wherein the virtual camera is configured to view the virtual environment from a first-person perspective and at a camera height, obtaining a posture of the avatar model, obtaining an angular displacement between the camera orientation and the model orientation, determining camera height of the virtual camera based on the posture and the angular displacement, positioning the virtual camera based on the camera height, rendering a video frame of the virtual environment by the virtual camera at the camera height; and providing for display the video frame on a display device.

### CROSS-REFERENCE TO RELATED APPLICATIONS

The present application claims priority to and the benefit of U.S. Provisional Patent Application No. 63/687,614 entitled SYSTEMS AND METHODS FOR INTERACTING WITH A VIRTUAL ENVIRONMENT filed Aug. 27, 2024, the disclosure of which is incorporated herein by reference in its entirety.

### BACKGROUND

Movement in and interaction with virtual environments has become commonplace in many interactive software applications. Users control an avatar through which the user views, moves, and interacts with the environment. Immersion in the virtual environment is increased by realistic simulation of avatar movements and traversal of the virtual environment.

### SUMMARY

In some aspects, the techniques described herein relate to a method of animating a virtual camera associated with a virtual character in a video environment, the method including: at a computing device: establishing a virtual camera at a first location relative to an avatar model of the virtual character, wherein the virtual camera has a camera orientation and the avatar model has a model orientation, wherein the virtual camera is configured to view the virtual environment from a first-person perspective and at a camera height; obtaining a posture of the avatar model; obtaining an angular displacement between the camera orientation and the model orientation; determining camera height of the virtual camera based on the posture and the angular displacement; positioning the virtual camera based on the camera height; rendering a video frame of the virtual environment by the virtual camera at the camera height; and providing for display the video frame on a display device.

In some aspects, the techniques described herein relate to a method of animating a virtual camera associated with a virtual character in a video environment, the method including: at a computing device: establishing a virtual camera at a first location of an avatar model of the virtual character, wherein the virtual camera has a camera orientation and the avatar model has a model orientation based at least partially on lock points relative to a ground of the virtual environment; obtaining a posture of the avatar model; based on the posture of the avatar model, selecting a range of motion of the camera orientation relative to the model orientation from at least a first range of motion and a second range of motion; obtaining an angular displacement between the camera orientation and the model orientation; based at least partially on selecting the first range of motion; not moving at least one lock point of the avatar model relative to the ground based on the angular displacement and the range of motion; and based at least partially on selecting the second range of motion, moving at least one lock point of the avatar model relative to the ground based on the angular displacement and the range of motion.

In some aspects, the techniques described herein relate to a method of animating an avatar model in a virtual environment, the method including: at a computing device: establishing the avatar model in the virtual environment, wherein the avatar model has a model orientation; establishing a virtual camera relative to the avatar model, wherein the virtual camera has a camera orientation relative to the model orientation; obtaining a posture of the avatar model; receiving a movement input having a movement input magnitude and movement input direction; based at least partially on the posture being a supine posture, determining a movement speed of the avatar model in the virtual environment wherein the movement speed is based at least partially on the camera orientation and the model orientation; and moving the avatar model in the virtual environment in accordance with the movement speed.

In some aspects, the techniques described herein relate to a method of animating an avatar model in a virtual environment, the method including: at a computing device: establishing the avatar model in the virtual environment, wherein the avatar model has a model orientation; establishing a virtual camera relative to the avatar model, wherein the virtual camera has a camera orientation relative to the model orientation; receiving a first movement input magnitude; receiving a first movement input direction; determining a first movement command direction based on the first movement input direction and the camera orientation; based on the first movement input magnitude being associated with a run movement speed, selecting a first run animation from a plurality of run animations based at least partially on the first movement command direction relative to the model direction; and moving the avatar model in the virtual environment in the movement command direction in accordance with the first run animation.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and aspects of embodiments of the disclosure will be set forth in the description which follows, and in part will be obvious from the description, or may be learned by the practice of such embodiments. The features and aspects of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, non-schematic drawings should be considered as being to scale for some embodiments of the present disclosure, but not to scale for other embodiments contemplated herein. Understanding that the drawings depict some example embodiments, the embodiments will be described and explained with additional specificity and detail through the use of the accompanying drawings in which:

FIG. 1 is a perspective view of a virtual environment, according to some embodiments of the present disclosure.

FIGS. 2-1 and 2-2 illustrate a point-of-view (POV) of an avatar model, according to some embodiments of the present disclosure.

FIG. 3-1 through 3-3 illustrate a field of view (FOV) of a virtual environment, according to some embodiments of the present disclosure.

FIG. 4-1 through 4-4 illustrate a movement of a virtual camera in different postures of an avatar model, according to some embodiments of the present disclosure.

FIGS. 5-1 and 5-2 illustrate relationships of angular displacement to camera height in different postures of an avatar model, according to some embodiments of the present disclosure.

FIG. 6 is a graph illustrating an embodiment of a supine posture that has a +180° range or motion (ROM) of angular displacement and a non-linear change in camera height as a function of the angular displacement, according to some embodiments of the present disclosure.

FIG. 7 illustrates a relationship between the angular displacement and the camera height including a decrease in camera height and an increase in camera height, according to some embodiments of the present disclosure.

FIGS. 8-1 and 8-2 illustrate video frames showing movement of POV model with camera movement, according to some embodiments of the present disclosure.

FIG. 9 is a flowchart illustrating an embodiment of a method of varying camera height, according to some embodiments of the present disclosure.

FIG. 10 is a flowchart illustrating an embodiment of a method of determining a movement speed of the avatar in the virtual environment while in a supine posture, according to some embodiments of the present disclosure.

FIG. 11-1 through 11-3 are top views of an avatar model with a changing camera orientation in a standing posture, according to some embodiments of the present disclosure.

FIGS. 12-1 and 12-2 are top views of an avatar model with a changing camera orientation in a crouching posture, according to some embodiments of the present disclosure.

FIGS. 13-1 and 13-2 are top views of an avatar model with a changing camera orientation in a supine posture, according to some embodiments of the present disclosure.

FIGS. 14-1 and 14-2 are graphs of base movement speed relative to a movement input magnitude, according to some embodiments of the present disclosure.

FIG. 15-1 through 15-3 are speed graphs of movement speed relative to direction, according to some embodiments of the present disclosure.

FIG. 16-1 through 16-4 are scalar graphs of scalar values relative to movement direction that scale a base movement speed, according to some embodiments of the present disclosure.

FIGS. 17-1 and 17-2 are movement speed graphs for different postures, according to some embodiments of the present disclosure.

FIG. 18 is a flowchart illustrating a method of moving an avatar with a run animation, according to some embodiments of the present disclosure.

FIG. 19 is a movement chart that illustrates movement speeds and animation sectors associated with different run animations, according to some embodiments of the present disclosure.

### DETAILED DESCRIPTION

The present disclosure relates generally to the presentation of and interaction with a virtual environment in an interactive software application. A user views and interacts with the virtual environment via an in-environment avatar. More particularly, the present disclosure relates to the presentation of and interaction with a virtual environment via an avatar configured to move through a plurality of postures in the virtual environment. For example, the avatar may be a humanoid avatar or other upright avatar having at least a standing posture and a supine posture. In other examples, the avatar has at least a standing posture, a crouching posture, and a supine posture.

In some embodiments, the user views the virtual environment through a virtual camera positioned relative to the avatar and configured to simulate a first-person perspective of the avatar in the virtual environment. In some embodiments, the user interacts with the virtual environment through movement of the avatar within the virtual environment. The virtual camera and/or movement of the avatar may exhibit different behaviors depending on the posture of the avatar. For example, the virtual camera may change position relative to the avatar when the user views the environment while the avatar is in a supine position differently than when the user views the environment while the avatar is in a standing position. In some examples, the avatar moves within the virtual environment differently in the supine position than in the standing position.

In some embodiments, the virtual camera rotates relative to the avatar at a constant camera height relative to the avatar model as the camera orientation changes relative to the model orientation. In a standing posture, the camera orientation may have a first range of motion (ROM) relative to the model orientation simulating a head movement of the avatar. As a user instructs the virtual camera to change camera orientation, for example, the virtual camera may remain at a constant camera height relative to the ground or other surface of the virtual environment upon which the avatar model is positioned. In some embodiments, the virtual camera shifts vertically (e.g., camera height changes) in response to an angular displacement of the camera orientation relative to a model orientation when the model is in a supine posture. For example, the supine posture may allow a rotation of the camera orientation relative to the model orientation to simulate the avatar rolling on the ground. In some embodiments, the virtual camera changes camera height as the camera orientation changes to simulate the height difference between the avatar's point of view (POV) when supine on the avatar's back versus the avatar's POV when supine on the avatar's front. In some embodiments, the avatar model is visible in the field of view (FOV) rendered for presentation to the user. In such embodiments, the avatar model may impair and/or block the user's view of the virtual environment based on the location of the virtual camera relative to the avatar model in other postures. Moving the virtual camera vertically based on camera orientation relative to the avatar model may simulate the movement of a humanoid avatar or other upright avatar in the virtual environment in a supine position.

In some embodiments, the user provides movement inputs to move the avatar relative to the virtual environment. In some examples, the avatar can move within the virtual environment at a plurality of speeds, such as a walk movement speed and a run movement speed. In conventional movement of avatars in a first-person presentation in interactive software applications, a run movement speed is available in a forward movement direction. For example, a user may instruct the avatar to sprint forward. The movement speed is conventionally limited to walk movement speeds in a backward direction and/or strafe directions. In some embodiments according to the present disclosure, an avatar has both a walk movement speed and a run movement speed with a walk animation and a run animation associated with each, respectively, in any direction in plane with the ground. In some embodiments, the movement input includes a movement direction input and a movement magnitude input. The movement direction input instructs the interactive software application to move the avatar in a direction relative to the camera orientation, the model orientation, or the virtual environment. The movement magnitude input instructs the interactive software application to move the avatar with an associated speed. For example, an avatar may move backward in response to a backward movement direction input, and the avatar may walk in response to a first movement magnitude input and run or sprint in response to a second movement magnitude input.

In some embodiments, a movement speed of the avatar is based at least partially on an angular displacement between the camera orientation and the movement direction. For example, the avatar may have a walk speed of a maximum of 1.0 and a run speed of 2.0. In at least one example, the movement speed is scaled based on an angular displacement of the camera orientation and the movement direction. In the above example, the avatar may run forward with the camera orientation and movement direction aligned, at the full 2.0 speed, while the avatar may run laterally (e.g., strafe) relative to the camera orientation at a movement speed of 1.6 (e.g., an 80% scaling of the base run movement speed). In some embodiments, both the walk movement speed and the run movement speed are scaled based on an angular displacement of the camera orientation and the movement direction. Scaling the movement speed based on an angular displacement of the camera orientation and the movement direction may simulate a human, a bipedal entity, or another upright entity moving more carefully when traversing ground in other directions other than the direction in which the entity is looking.

In some embodiments, a movement speed of the avatar is based at least partially on an angular displacement between the camera orientation and the model orientation. As described above, in some embodiments, the avatar model orientation remains in a first direction while the camera orientation changes. In some embodiments, the movement speed is scaled based on an angular displacement of the camera orientation relative to the model orientation to simulate the biomechanics of a human, a bipedal entity, or another upright entity moving more slowly in other directions than the direction in which their body it oriented. In some postures, such as a standing posture, the model orientation may substantially continuously change to match that of the camera orientation. In other words, the avatar model turns to follow where the user orients the camera.

In some postures, the avatar model remains locked to the virtual environment, such as in a supine posture, and the camera orientation simulates the avatar's body rolling and/or twisting while supine. In a supine posture, scaling the movement speed based at least partially on an angular displacement between the camera orientation and the model orientation may simulate the speed difference between crawling on one's front relative to crab-walking lying on one's back. In some embodiments, the movement speed is scaled based at least partially on the camera orientation, the model orientation, and the movement direction. For example, a first scalar is determined based on the angular displacement between the movement direction and the camera orientation, and a second scalar is determined based on the angular displacement between the camera orientation and the model orientation.

In some embodiments, the virtual environment is provided by an interactive software application executed by a computing device. The computing device may be any computing device capable of executing instructions from memory to perform at least part of any method described herein. For example, the computing device may be a local computing device to the user, such as a desktop computer, laptop computer, tablet computer, hybrid computer, wearable computing device (including head-mounted computing devices), smartphone, gaming console, smart television or other appliance, and other computing devices. In some examples, the computing device may be a remote computing device from the user, such as a server computer or in communication with a local client device via a server computer. In some examples, the virtual environment is displayed on a local display to the user, while the interactive software application is executed remotely. In some examples, the user provides user inputs to the interactive software application through input devices that are remote to the computing device.

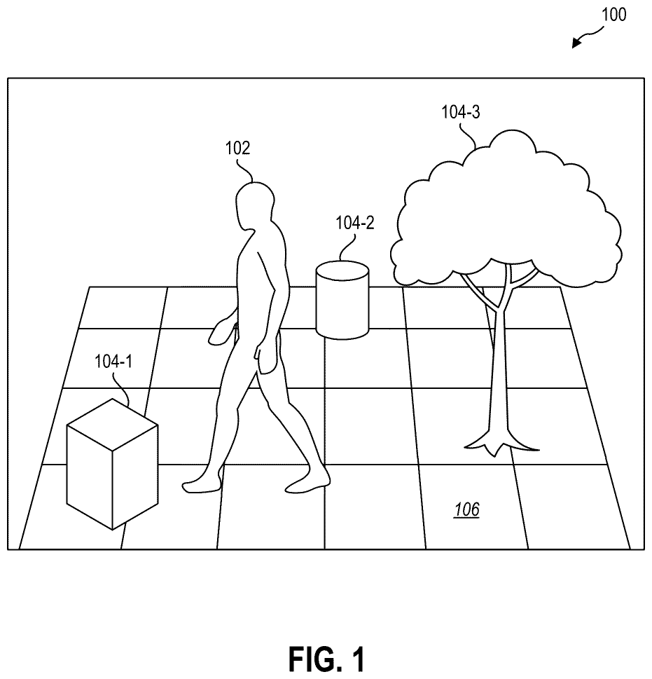

FIG. 1 is a perspective view of an embodiment of a virtual environment 100. The virtual environment 100 includes an avatar model 102 that represents the user's avatar and location in the virtual environment 100. The user can provide various inputs to the interactive software application to move the avatar model 102 in the virtual environment 100 and interact with one or more virtual objects 104-1, 104-2, 104-3. In some embodiments, the avatar model 102 is supported by and/or positioned relative to the ground 106 of the virtual environment 100. As the user provides inputs to the computing device executing the interactive software application, the inputs are converted to instructions to move the avatar, interact with the virtual environment 100, and/or view the virtual environment 100 from the POV of the user's avatar model 102.

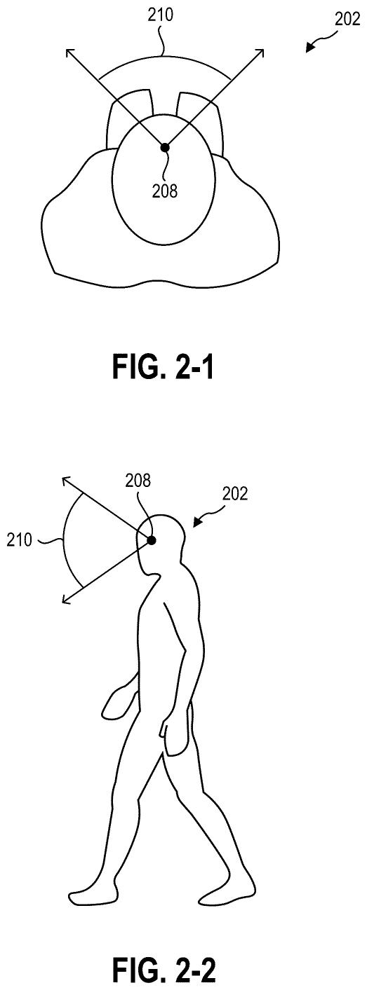

In some embodiments, the interactive software application provides a first-person POV (FPV) of the virtual environment 100 by rendering the virtual environment based on a virtual camera location and settings. In some embodiments, the interactive software application renders the POV of the virtual environment 100 to simulate the perspective of the avatar model 102. For example, FIG. 2-1 and FIG. 2-2 illustrate an example of an FPV of an avatar model 202. In some embodiments, the interactive software application renders the virtual environment from a viewpoint 208 approximating the eyes or the head of the avatar model 202. A FOV 210 simulating the FOV of the avatar model's eyes defines the size of the rendered frame.

In some embodiments, the virtual camera is located in a different location from the avatar model and/or the avatar model 202 is not rendered from the perspective of the virtual camera. For example, in an interactive software application for a single user, the interactive software application may ignore the avatar model 202 for the FPV rendered by the virtual camera, and the avatar model 202. When a second user views the virtual environment containing the avatar model 202 of the first user, the FPV rendered for the second user may include the avatar model of the first user. Similarly, the FPV rendered for the second user may not include the avatar model of the second user's avatar. In such cases, the virtual camera may function at least partially independently of the avatar model 202.

FIG. 3-1 through FIG. 3-3 illustrate the virtual camera 308 placement and perspective in a virtual environment 300. In some embodiments, the virtual camera 308 is positioned at the viewpoint of an avatar model (e.g., viewpoint 208 of FIGS. 2-1 and 2-2). In some embodiments, the virtual camera 308 is located in the virtual environment 300 relative to the ground 306 or other surface that may support an avatar model. The virtual camera 308 has a FOV 310 that allows a user controlling the virtual camera 308 to view the virtual environment 300 including, but not limited to the virtual objects 304-1, 304-2, 304-3 in the virtual environment 300. The virtual camera 308 is positioned in the virtual environment 300 at a camera height 312 to simulate the perspective of the user or avatar of the user. In some embodiments, an interactive software application supports and/or provides a variety of avatar models 302 and/or customization of the avatar models 302. In such examples, the virtual camera may have a standard camera height 312 to provide a uniform experience to users irrespective of changes in the avatar model 302. In at least one example, different avatar models with different heights would have different sightlines within the virtual environment 300. Different sightlines may provide different experiences to users based on the selected avatar model 302. In some embodiments, such variations may be beneficial, but, in some embodiments, a uniform experience irrespective of avatar model 302 (such as in competitive applications) may be desirable. As will be discussed herein, the camera height 312 changes in different postures and based on camera orientation.

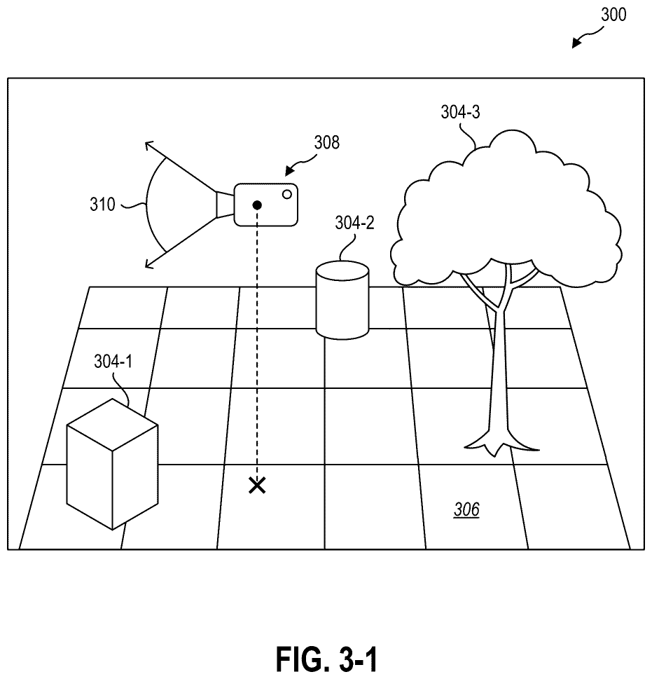

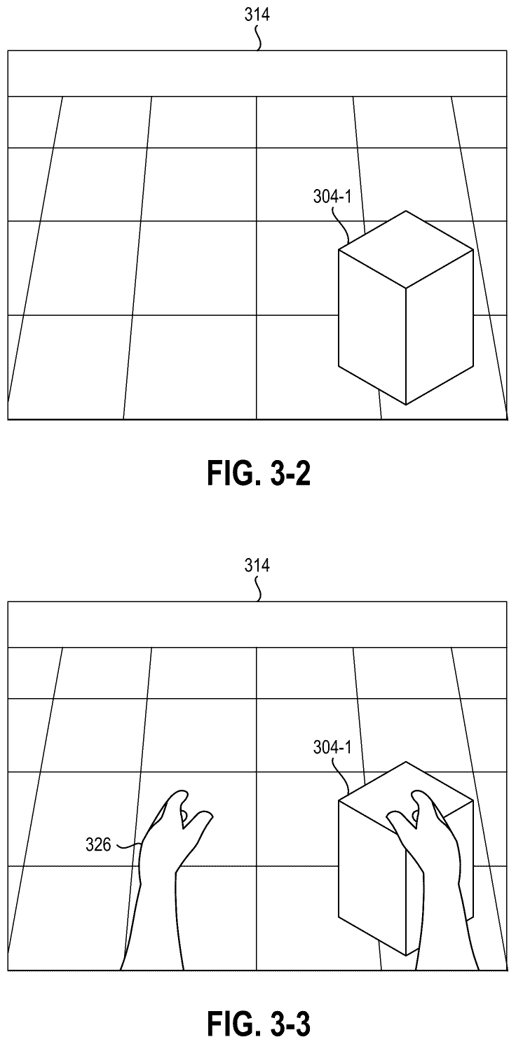

FIG. 3-2 illustrates a frame 314 rendered from the perspective of the virtual camera 308 of FIG. 3-1. The frame 314 includes box virtual object 304-1 in the lower corner of the frame 314, indicating the location of the virtual object 304-1 relative to the virtual camera. In some embodiments, the rendered frame 314 further includes a POV model 326, as shown in FIG. 3-3. The POV model 326 may be separate from an avatar model rendered in the virtual environment. For example, rendering only the POV model 326 overlaid on the virtual environment 300 in frame 314 from the perspective of the virtual camera may require less computational resources than calculating an avatar model in the virtual environment and rendering the frame 314 to include a portion of the avatar model. In some embodiments, the POV model 326 is higher resolution and/or has higher resolution textures applied thereto compared to an avatar model. In some examples, the POV model 324 may include only a portion of the user's avatar to represent the user's avatar while requiring less computational resources. In the embodiments described above with avatar models of different heights, the virtual camera may be positioned to provide a uniform experience to the user, but not align with the avatar model. In such embodiments, the rendering of a POV model 324 in the frame 314 allows the appearance of the user's avatar aligning with the virtual camera position irrespective of the avatar model height.

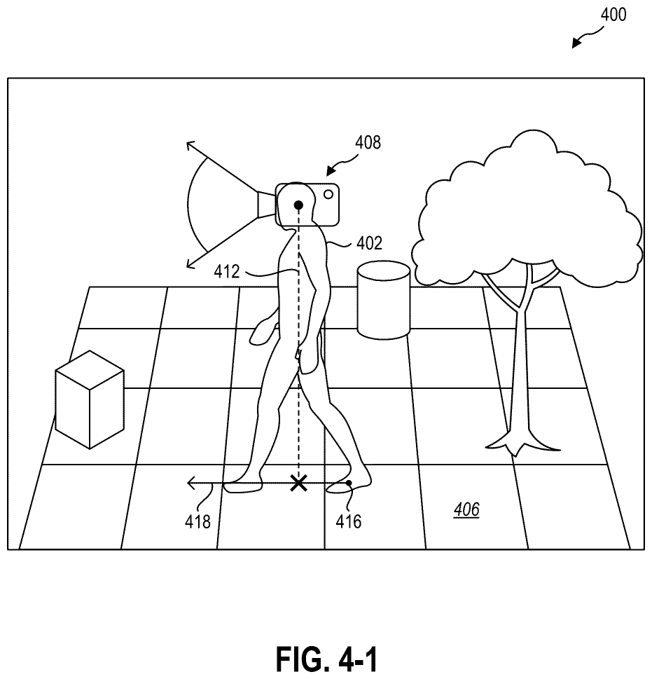

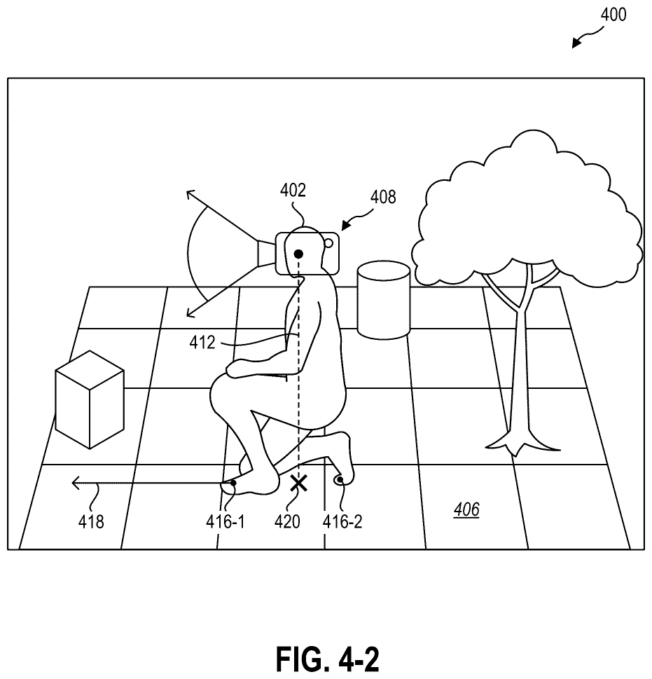

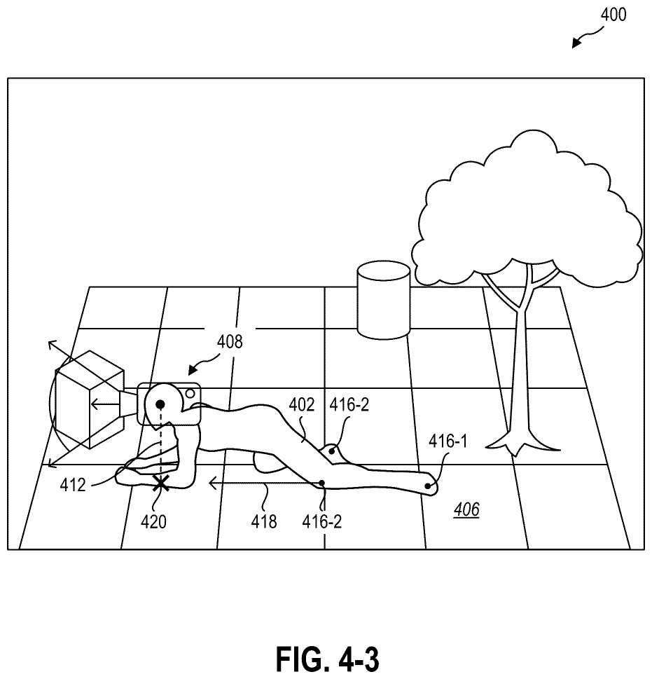

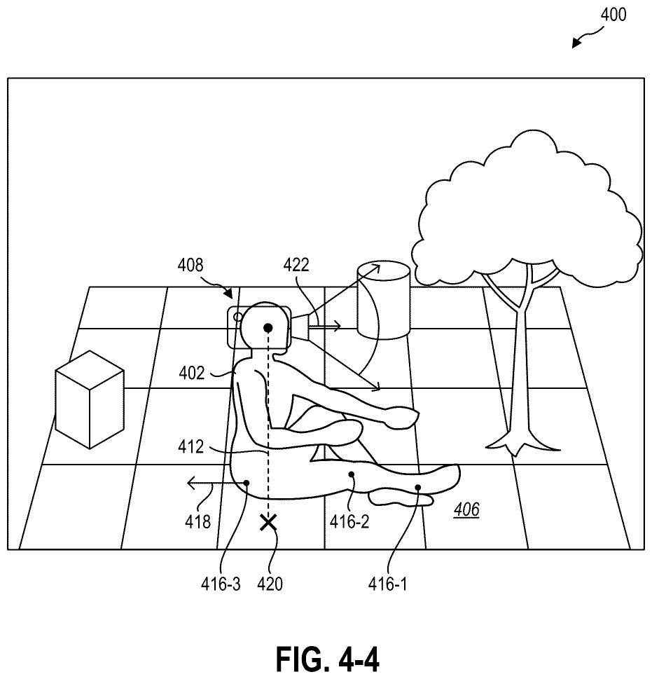

In some embodiments, the camera height is determined based at least partially on the posture of the avatar model. In some embodiments, the virtual camera is positioned in the virtual environment relative to a location and orientation of the model. FIG. 4-1 is a perspective view of an embodiment of a virtual camera 408 and an avatar model 402 in a virtual environment 400. The virtual camera 408 is positioned relative to the avatar model 402 at a camera height 412. In some embodiments, the virtual camera 412 is positioned at the camera height 412 above the ground 406 based at least partially on lock points 416 of the avatar model 402 relative to the ground 406. For example, a lock point 416 of the model is a location at which the avatar model 402 contacts the ground 406 or another surface upon with the avatar model 402 is positioned. The lock point(s) 416 allows a portion of the model to lock relative to the ground 406 during animations, for example, to sliding or other artifacts and animations that appear unnatural to a viewer. In some embodiments, the lock point 416 is directly beneath a geometric or volumetric center of the avatar model 402.

In some embodiments, the avatar model 402 has a plurality of lock points 416-1, 416-2 relative to the ground 406, such as illustrated in FIG. 4-2. In the standing posture of FIG. 4-1, the feet of the avatar model 402 are relatively close to one another, and a single lock point 416 relative to the geometric or volumetric center of the avatar model 402 provides a reference for the animations of the avatar model 402, a model orientation 418 of the avatar model 402, and the camera location of the virtual camera 408. In the illustrated embodiment of a crouching posture of FIG. 4-2, the avatar model 402 has a lock point 416-1, 416-2 in each foot such that animations of the avatar model 402 walking forward or turning (in response to changes to the model orientation 418) do not exhibit foot slides. In such examples, the location of the virtual camera 408 may be based at least partially on the lock point(s). In at least one example, the camera height 412 changes between the standing posture and the crouching posture to simulate the change in height of the avatar model 402 relative to the ground. For example, the virtual camera 408 may move to a second camera height 412 in the crouching posture. In the examples of a standing posture and/or a crouching posture, the camera height 412 may be substantially constant as the user moves the avatar model 402 and changes a camera orientation of the virtual camera 408 relative to the virtual environment 400.

In some embodiments, the camera height 412 may vary within a posture to better simulate movement of a viewpoint of the avatar in such posture and to avoid occlusion by or clipping through the avatar model 402. FIG. 4-3 and FIG. 4-4 illustrate the avatar model 402 in a supine posture. FIG. 4-3 illustrates an embodiment of the avatar model 402 in a forward supine posture, and FIG. 4-4 illustrates an embodiment of the avatar model 402 in a backward supine posture. In the forward supine posture the avatar model 402 is positioned with the avatar model 402 forward of the feet in the model orientation 418. In some embodiments, the feet are lock points 416-1, 416-2 and the avatar model 402 is positioned forward of the feet lock points 416-1, 416-2 relative to the model orientation 418. In some embodiments, the feet are lock points 416-1, 416-2 and the hips or center of the avatar model 402 are a third lock point 416-3 of the avatar model 402. The third lock point 416-3 is positioned forward of the feet lock points 416-1, 416-2 relative to the model orientation 418. When the avatar model 402 is in the forward supine position, the virtual camera 408 is positioned with a first camera height 412 above a reference point 420. In some embodiments, the reference point 420 is determined based at least partially on the model orientation 418 and a location of the lock point(s) 416-1, 416-2, 416-3.

As described herein, the camera orientation 422 may change relative to the model orientation 418. In some examples, such as in a standing posture and/or a crouching posture, the model orientation 418 may change at least partially based on the camera orientation 422. As will be described in more detail herein, such limited ROM simulates the avatar moving its feet when the “head” rotates to the limits of the ROM. In a supine posture, the camera orientation 422 may have an ROM that allows the virtual camera 408 to rotate a full 360° (e.g., +180° from the model orientation 418) to simulate the avatar rolling on the ground or other surface while the feet remain pointing the same direction relative to the avatar model 402 and the location of the virtual camera 408. In some embodiments, the ROM is scaled and/or limited by one of more equipped items or objects of the avatar model. For example, the ROM may be limited based on a carried weapon or a wore piece of armor. The ROM may be increased by an equipped item that alters one or more statistics or abilities of the avatar.

In some embodiments, the virtual camera 408 moves as the camera orientation 422 changes relative to the model orientation 418. In some embodiments, the reference point 420 above which the virtual camera 408 is located moves with the rotation of the camera orientation 422. In some embodiments, the camera height 412 changes with the rotation of the camera orientation 422. In some embodiments, the camera height 412 changes based on an angular displacement between the camera orientation 422 and the model orientation 418. For example, the forward supine position of FIG. 4-3 may have a lesser camera height 412 than the backward supine position of FIG. 4-4.

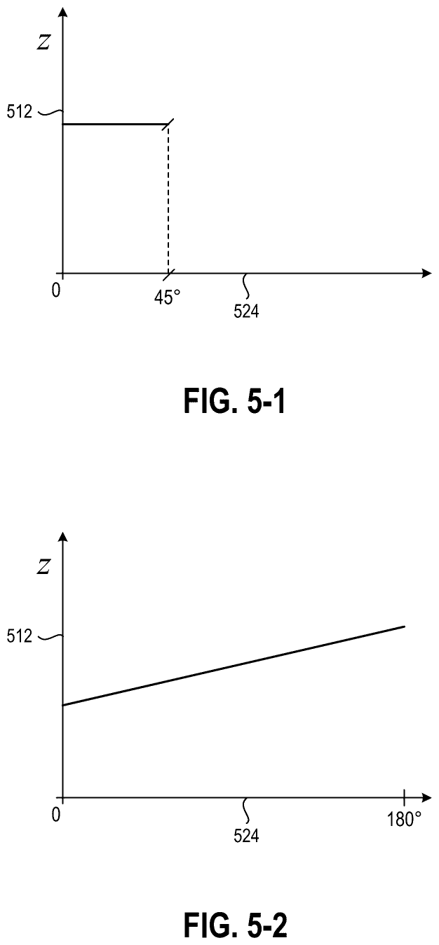

In some embodiments, different postures of the avatar model have different ROMs of the camera orientation relative to the model orientation. In some embodiments, different postures of the avatar model have different changes to the camera height based on the angular displacement of the camera orientation relative to the model orientation. FIG. 5-1 is a graph illustrating an embodiment of a ROM of a standing posture. In some embodiments, the standing posture has a first ROM of the camera orientation relative to the model orientation. In the illustrated embodiment of FIG. 5-1, the ROM is 45° but may have other values. Upon a user providing inputs to the interactive software application to move the camera orientation to or beyond the ROM of the standing posture, the interactive software application changes the model orientation. The camera height 512 remains substantially unchanged through the angular displacement 524 in the illustrated embodiment of a standing posture.

In contrast, FIG. 5-2 is a graph illustrating an embodiment of a ROM of a supine posture. In some embodiments, the supine posture has a second ROM of the camera orientation relative to the model orientation different from the first ROM of the standing posture. In some embodiments, the supine posture has ±180° angular displacement 524 and linear change in camera height 512 as a function of the angular displacement. Such a change in the camera height 512 based on the angular displacement 524 provides the low camera height 512 at the forward supine posture described in relation to FIG. 4-3 (e.g., 0° angular displacement 524) and the high camera height 512 at the backward supine posture described in relation to FIG. 4-4 (e.g., 180° angular displacement 524).

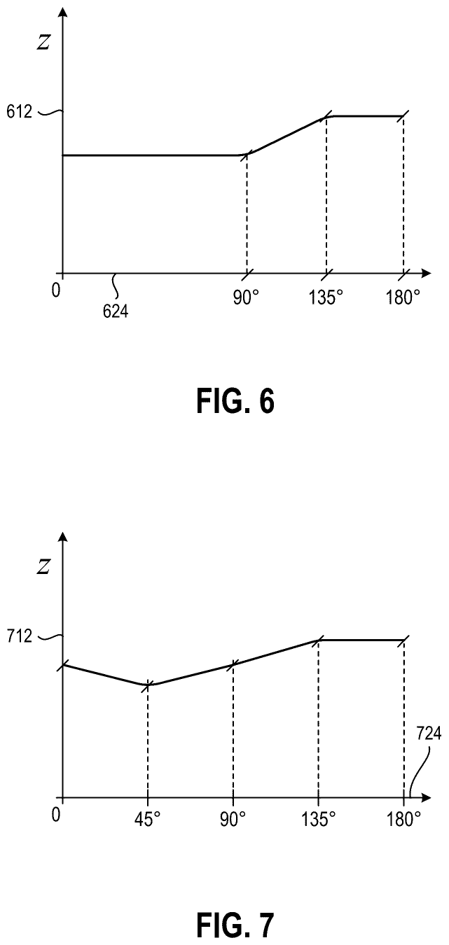

The camera height may vary by other relationships than the linear relationship of FIG. 5-2. FIG. 6 is a graph illustrating an embodiment of a supine posture that has a ±180° ROM of angular displacement 624 and a non-linear change in camera height 612 as a function of the angular displacement 624. The illustrated embodiment of FIG. 6 allows a ±90° ROM of the angular displacement 624 with no substantial change in the camera height 612, while the camera height increases between 90° and 135° of angular displacement 624. The camera height 612 then remains substantially unchanged for angular displacements 624 between 135° and 180°. Such a relationship between the angular displacement 624 and the camera height 612 simulates the user's view remaining substantially level while in the forward supine posture and substantially level in the backward supine posture, but the perspective of the user's view changing as the avatar “rolls over” between the forward supine posture and backward supine posture.

In yet other embodiments and referring now to the embodiment illustrated in FIG. 7, the relationship between the angular displacement 724 and the camera height 712 includes a decrease in camera height 712 and an increase in camera height 712 in different portions of the curve. For example, FIG. 7 illustrates an embodiment in which the supine posture has ±180° ROM through which the camera height 712 initial decreases from 0° to 45° of angular displacement 724, before increasing from 45° through 90° to 135°. The camera height 712 then remains substantially unchanged for angular displacements 724 between 135° and 180°. Such a relationship between the angular displacement 724 and the camera height 712 simulates the user's view being higher (e.g., a higher camera height 712) when in the forward supine posture due to simulating the avatar's perspective being propped up on hands or elbows before rolling onto the avatar's side as the angular displacement 724 between the camera orientation and the model orientation increases.

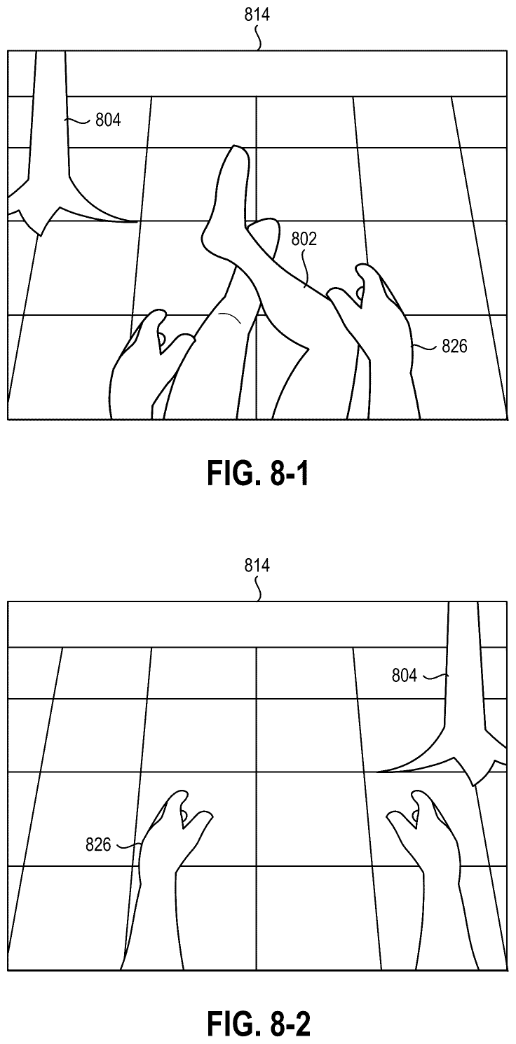

The changes in the camera height can aid in simulating the movements of a human or humanoid character moving while supine. Further immersion in the simulation may be created through the rendering of at least a portion of the avatar model 802 in the frame 814 from the POV of the virtual camera, such as illustrated in the embodiment of FIG. 8-1. In some embodiments, the frame 814 includes at least a portion of the avatar model 802 and at least a portion of the POV model 826. In some embodiments, the POV model 826 is moved, rotated, or otherwise animated independently of the avatar model 802. For example, FIG. 8-2 illustrates a frame 814 rendered from the perspective of the virtual camera turned 90° to the left relative to the frame 814 illustrated in FIG. 8-1 (e.g., the tree virtual object 804 of FIG. 8-1 has moved to the right-hand side of the frame 814 in FIG. 8-2). When the camera orientation of the virtual camera changes angular displacement relative to the model orientation, the POV model 826 (and/or the avatar model 802) may move or animate. In some embodiments, when the camera orientation of the virtual camera changes angular displacement relative to the model orientation, the POV model 826 (and/or the avatar model 802) may move or animate in addition to a change in camera height. In the illustrated embodiment of FIG. 8-2, the POV model 826 rotates or tilts relative to the camera orientation based on the angular displacement of the camera orientation to the model orientation. In some embodiments, the POV model 826 may move or animate relative to the camera orientation based on the angular displacement in other postures, including a standing posture and/or crouching posture.

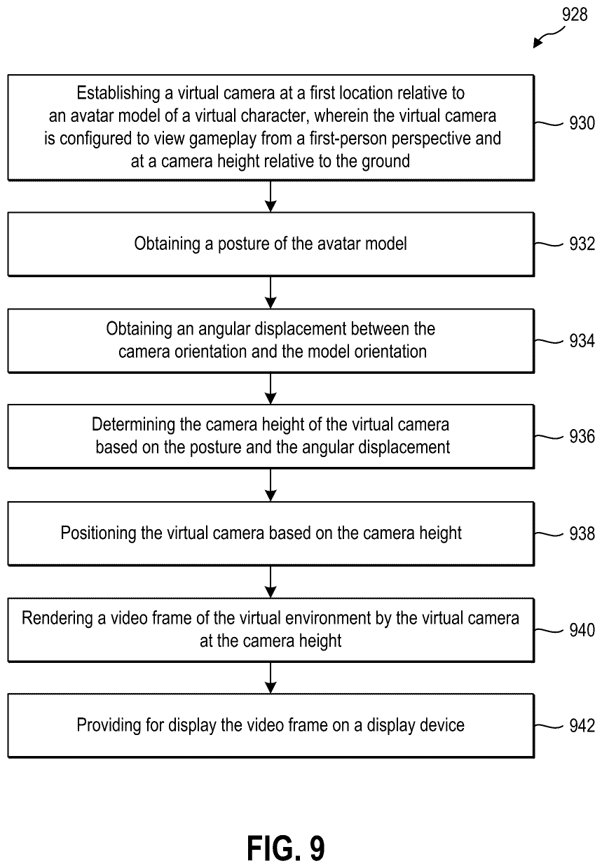

FIG. 9 is a flowchart illustrating an embodiment of a method 928 of varying camera height such as that described in relation to FIG. 4-1 through FIG. 8-2 for execution on a computing device. In some embodiments, the method 928 includes establishing a virtual camera at a first location relative to an avatar model of a virtual character at 930, where the virtual camera is configured to view a virtual environment from a first-person perspective and a camera height above the ground or other surface upon which the avatar model is located. In some embodiments, the virtual camera is positioned based at least partially on at least one lock point of the avatar model. In some embodiments, the virtual camera is positioned based at least partially on a center of the avatar model. In some embodiments, the virtual camera is positioned based at least partially on a head of the avatar model. In some embodiments, the virtual camera is positioned based at least partially on a reference point of the avatar model.

The method 928 further includes obtaining a posture of the avatar model at 932. In some embodiments, the posture is a standing posture. In some embodiments, the posture is a crouching posture. In some embodiments, the posture is a supine posture. In some embodiments, the posture is selected from a plurality of postures including at least a supine posture. The method 928 further includes obtaining an angular displacement between the camera orientation and the model orientation at 934. In some examples, the angular displacement is limited based on the posture. In some examples, the angular displacement is any value between 0° and 180°.

In some embodiments, the method 928 includes determining a camera height of the virtual camera based at least partially on the posture and the angular displacement at 936 and positioning the virtual camera based on the camera height at 938. For example, the camera height may be determined by one or more relationships relative to the angular displacement, wherein the particular relationship is selected based on the posture. As described herein, a standing posture may have a relationship with a substantially constant camera height relative to the angular displacement, while the supine posture may have a relationship with a camera height that is linear, nonlinear, or noncontinuous relative to the angular displacement between the camera orientation and the model orientation.

The method 928 further includes rending a video frame (such as described in relation to FIGS. 3-2 and 3-3 and in relation to FIGS. 8-1 and 8-2) of the virtual environment by the virtual camera at the camera height at 940 and providing for display the video frame on a display device. As described herein, the computing device that renders the video frame may be remote to the display device and/or the user. In some embodiments, the computing device that renders the video frame may be local to the display device and/or the user. In some embodiments, the video frame is rendered by a client computing device while at least a portion of the virtual environment is calculated and/or provided to the client computing device by a second computing device, such as a server. In some embodiments, the client computing device is local to the user. In some embodiments, the client computing device provides the video frame to a display device remote to the client computing device and/or local to the user.

By changing the camera height of the virtual camera, systems and methods described herein may more accurately simulate a supine avatar to immerse a user in a virtual environment. In some embodiments, systems and methods described herein may improve the user experience by changing the camera height of the virtual camera to prevent occlusion of or interference with the user's view of the virtual environment when in a posture and/or camera orientation relative to the avatar model.

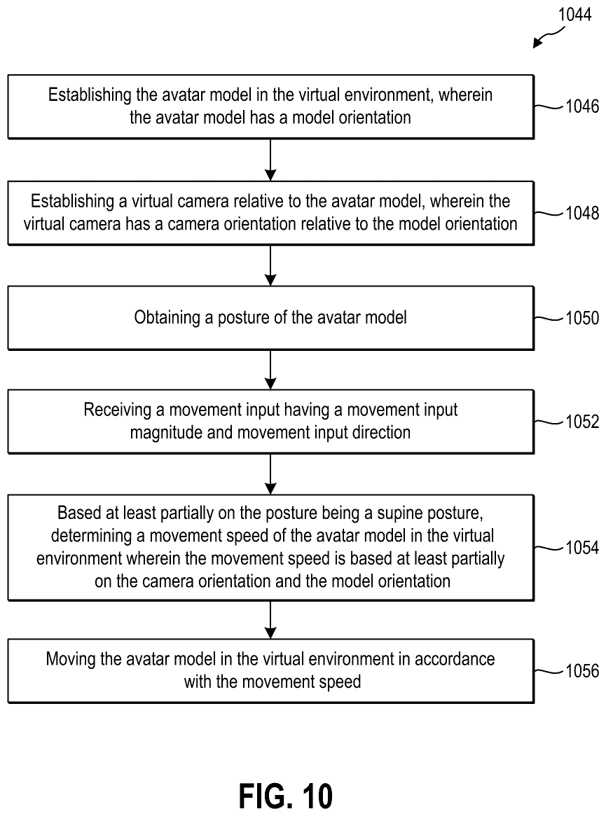

In some embodiments, systems and methods according to the present disclosure provide improved immersion in a virtual environment by simulating movement speeds of an avatar in a virtual environment based at least partially on a posture of the avatar. FIG. 10 is a flowchart illustrating an embodiment of a method 1044 of combining scalar values to determine a movement speed of the avatar in the virtual environment while in a supine posture. The method 1044 includes establishing an avatar model in the virtual environment at 1046, where the avatar model has a model orientation. In some embodiments, the model orientation is based at least partially on one or more lock points of the avatar model relative to the virtual environment. In some embodiments, the model orientation is based at least partially on one or more reference points of the avatar model relative to the virtual environment.

The method 1044 further includes establishing a virtual camera relative to the avatar model at 1048, wherein the virtual camera has a camera orientation relative to the model orientation. In some embodiments, the virtual camera is positioned in the virtual environment and/or relative to the avatar model according to any embodiment of the method described in relation to FIG. 9. In some embodiments, the virtual camera is positioned in the virtual environment and/or relative to the avatar such that the virtual camera is configured to view a virtual environment from a first-person perspective of the avatar and a camera height above the ground or other surface upon which the avatar model is located.

The method 1044 includes obtaining a posture of the avatar model at 1050 and receiving a movement input having a movement input magnitude and a movement input direction at 1052. In some embodiments, the posture is a standing posture. In some embodiments, the posture is a crouching posture. In some embodiments, the posture is a supine posture. In some embodiments, the posture is selected from a plurality of postures including at least a supine posture.

The movement input may be received from a user input device in data communication with the computing device performing at least a portion of the method 1044. For example, the user input device may be or include a keyboard, a computer mouse, a touch-sensitive device, a gamepad, a directional pad, a directional stick (including a joystick, thumbstick, or other analog directional input device), a motion-sensing device (including accelerometers, gyroscopes, or other motion-sensing devices), a motion-tracking device (including machine vision cameras or other sensors), a voice-recognition device, and combinations thereof. In some embodiments, the movement input magnitude and movement input direction are received from the same user input device. For example, the movement input may be received from an analog thumbstick and include both the movement input magnitude and movement input direction. In some embodiments, the movement input magnitude and movement input direction are received from different user input devices. For example, the movement input magnitude may be received from a computer mouse and the movement input direction may be received from a keyboard. In some embodiments, the movement input magnitude and movement input direction are received from different buttons, sensors, or input mechanisms of the same user input device. For example, the movement input may be received from an gamepad peripheral in communication with the computing device, wherein a thumbstick provides the movement input direction and a face button of the gamepad provides the movement input magnitude. In at least one embodiment, a movement input direction is received from a potentiometer of the thumbstick, and a movement input magnitude is received from a pressure sensor of a vertical click of the thumbstick.

Based at least partially on the obtained posture being a supine posture, the method 1044 further includes determining a movement speed of the avatar model in the virtual environment based at least partially on the camera orientation and the model orientation. The movement speed is determined for a movement command direction. The movement command direction is determined by the movement input direction relative to the camera orientation. For example, a forward movement input direction provides a forward movement command direction relative to the camera orientation. A left lateral movement input direction provides a left lateral (strafc) movement command direction relative to the camera orientation.

In some embodiments, the movement input magnitude is associated with a base movement speed. For example, the movement input magnitude may be 1.0 (e.g., 100% of the magnitude of a thumbstick or a binary magnitude of a digital button, such as a keyboard) and the movement input magnitude of 1.0 corresponds to a base movement speed of 1.0. IN some embodiments, a run command (or sprint command) may be associated with a base movement speed of 2.0 in a posture for which the run movement speed is available, such as a standing posture. In other postures, a receiving a run command from the user input device may instruct the interactive software application to change the posture of the avatar to a standing posture to allow run movement speed.

The base movement speed is, in some embodiments, then scaled based on or more scalar values. The scalar values may include values determined by the camera orientation relative to movement command direction, the model orientation model orientation relative to movement command direction, the angular displacement of camera orientation and model orientation, the posture, or other parameters.

For example, the movement speed may be determined by scaling the base movement speed by a camera scalar of a difference between the camera orientation and the movement command direction in the X-Y plane of the virtual environment. For example, the angular difference between the camera orientation and the movement command direction used to determine the camera scalar does not include the vertical angular difference of the virtual camera tilting upward or downward. In such an example, the camera scalar simulates a human character (or other character) being able to move more quickly in the direction the character is looking relative to other directions.

In some examples, the movement speed may be determined by scaling the base movement speed by a model scalar of a difference between the model orientation and the movement command direction in the X-Y plane of the virtual environment. For example, the angular difference between the model orientation and the movement command direction used to determine the model scalar does not include any vertical angular difference of model tilting upward or downward. In such an example, the model scalar simulates a human character (or other character) being able to, biomechanically, move more quickly in the direction the character's body is oriented relative to other directions.

In some examples, the movement speed may be determined by scaling the base movement speed by a displacement scalar of an angular displacement between the camera orientation and the model orientation in the X-Y plane of the virtual environment. For example, the angular displacement between the camera orientation and the model orientation used to determine the model scalar does not include any vertical angular difference of the virtual camera and the model. In such an example, the displacement scalar simulates a human character (or other character) being able to move more quickly when looking in the direction the character's body is oriented relative to other directions.

The method 1044 further includes moving the avatar model in the virtual environment in according with the movement speed at 1056. In some embodiments, the method further include rendering a plurality of video frames of the virtual environment from the perspective of the virtual camera based on the movement of the avatar model and virtual camera associated therewith and providing for display on a display device, the plurality of video frames.

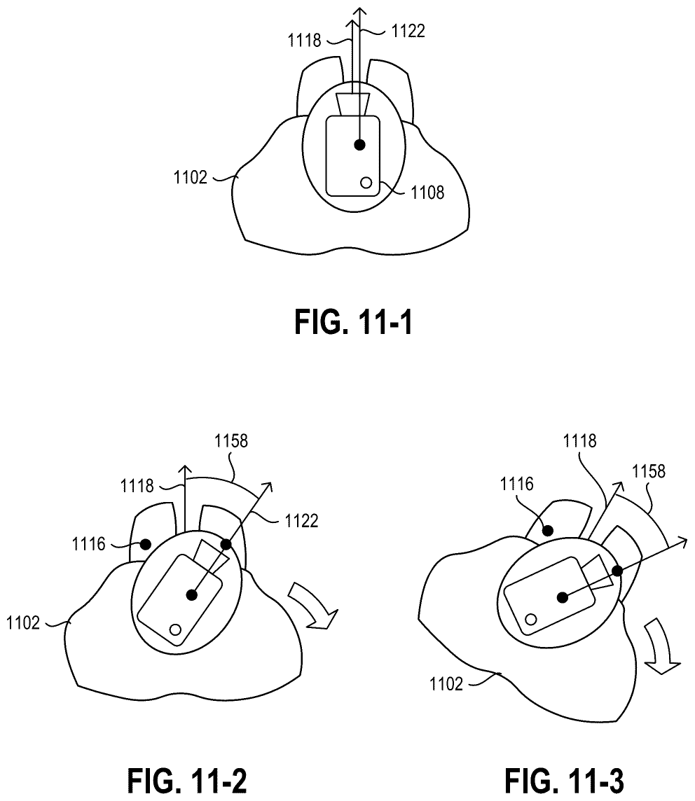

As described herein, the movement speed is based at least partially on the camera orientation and the model orientation. FIG. 11-1 is a top view of an embodiment of an avatar model with a model orientation relative to camera orientation in a first posture. In the first posture, the avatar model 1102 is in a standing posture. The avatar model 1102 has a model orientation 1118 directly forward of the avatar model 1102 in the virtual environment. A virtual camera 1108 is positioned relative to the avatar model 1102 and configured to simulate a first-person perspective of the avatar model 1102 in a camera orientation 1122. The embodiment of FIG. 11-1 shows the model orientation 1118 and the camera orientation aligned with no angular displacement therebetween.

Referring now to FIG. 11-2, the user has provided a user input to move the camera orientation 1122. In some embodiments, the camera orientation 1122 is able to move within a ROM in the standing posture. The camera orientation 1122 moves to an angular displacement 1158 with the model orientation 1118. When the angular displacement 1158 approaches, equals, or exceeds a limit of the ROM of the posture (such as the ±45° ROM described in relation to FIG. 5-1), the model orientation 1118 changes via movement of or rotation around one or more lock points 1116 of the avatar model 1102 as shown in FIG. 11-3.

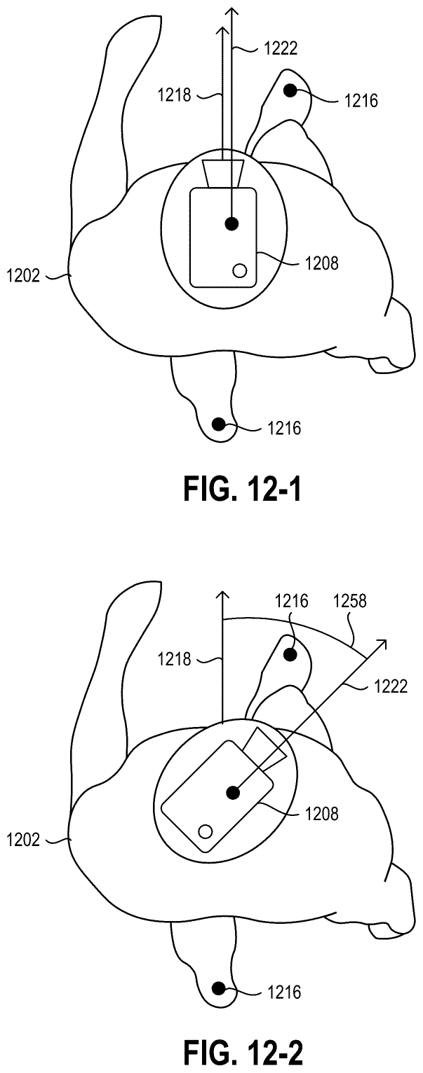

FIG. 12-1 is a top view of an embodiment of an avatar model 1202 in a second (crouching) posture. In some embodiments, the second posture has a different ROM of the camera orientation 1222 relative to the model orientation 1218. In some examples, the model orientation 1218 is based at least partially on lock points 1216. In FIG. 12-1, the model orientation 1218 and the camera orientation 1222 of the virtual camera 1208 are substantially aligned.

FIG. 12-2 is top view of the embodiment of an avatar model 1202 of FIG. 12-1 illustrating the increased ROM of the crouching posture. In some embodiments, the ROM of the crouching posture is greater than the standing posture, which allows an angular displacement 1258 of more than 45° without altering the model orientation 1218 and moving a lock point 1216.

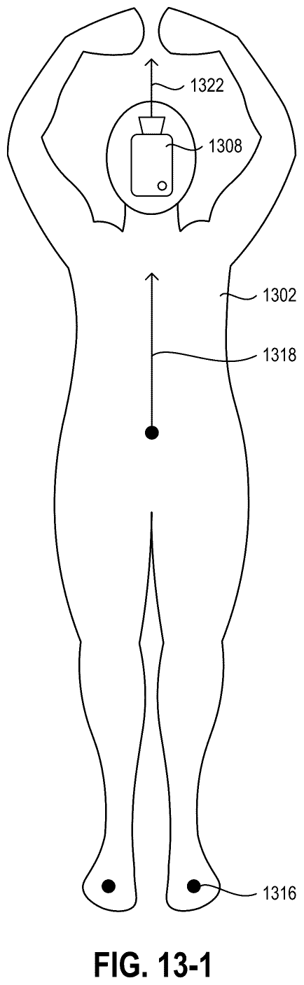

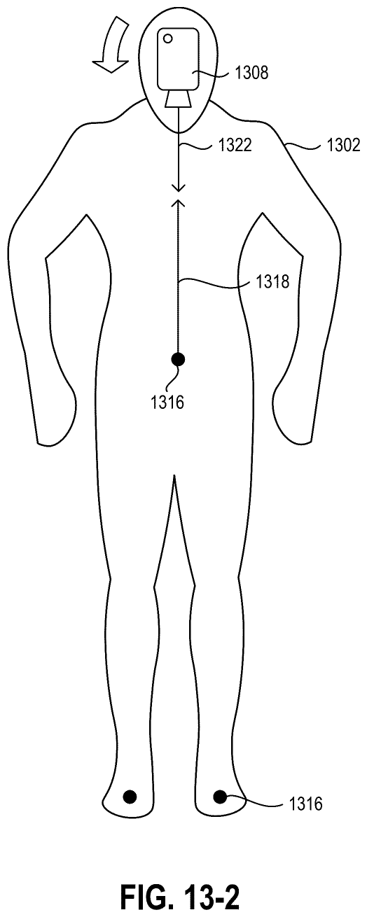

As described herein, in a supine posture, such as the embodiment of an avatar model 1302 of FIG. 13-1, the ROM of camera orientation 1322 relative to the model orientation 1318 is greater than the standing posture or the crouching posture and may be ±180°. FIG. 13-1 is a top view of an embodiment of an avatar model 1302 in a forward supine position. A virtual camera 1308 is positioned relative to the avatar model 1302 to simulate a first-person perspective of the avatar model 1302. In some embodiments, the model orientation 1318 is based at least partially on the lock point(s) 1316 of the avatar model 1302. In some embodiments, the model orientation 1318 is based at least partially on a reference point of the avatar model 1302. In some embodiments, the model orientation 1318 is based at least partially on a reference point relative to a lock point of the avatar model 1302.

The embodiment of FIG. 13-1 illustrates the forward supine posture in which the camera orientation 1322 of the virtual camera 1308 and the model orientation 1318 of the avatar model 1302 are substantially aligned with no angular displacement therebetween. Referring now to FIG. 13-2, the avatar is now depicted in the backward supine posture with the camera orientation 1322 oriented substantially opposite the model orientation 1318 with a 180° angular displacement therebetween. In the supine posture, in some embodiments, allows a ROM of ±180° of the virtual camera 1308 relative to the avatar model 1302 without moving at least one of the lock points 1316 of the avatar model 1302. For example, the relative position of the virtual camera 1308 relative to the lock points 1316 does not change between the forward supine position and the backward supine position. However, movement speeds are scaled depending on the movement command direction relative to the model orientation.

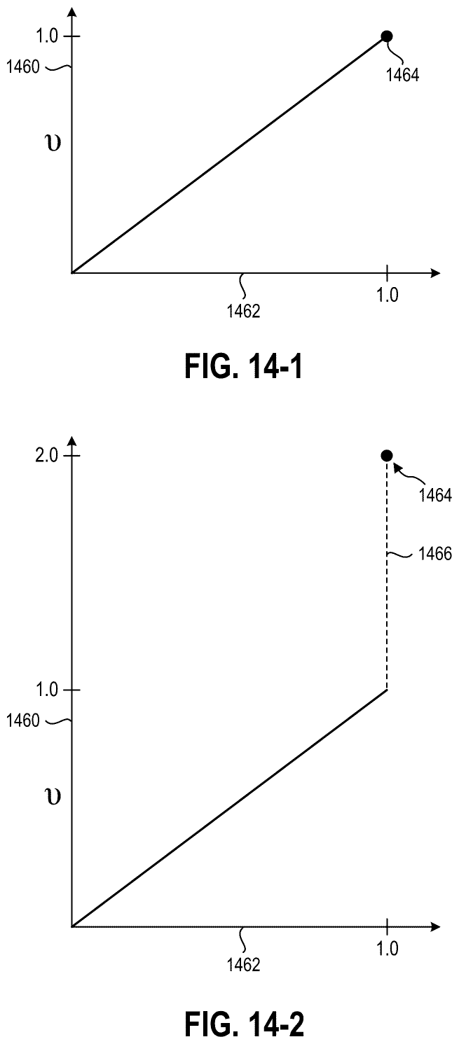

FIGS. 14-1 and 14-2 illustrate examples of a base movement speed 1460 relative to a movement input magnitude 1462. Referring to FIG. 14-1, in some embodiments, the movement input magnitude 1462 is a continuously variable input, such as from an analog thumbstick or other similar input device. The movement input magnitude can, therefore, vary from a 0.0 value to a 1.0 value through a range of motion of the user input device. In some embodiment, the maximum value of the movement input magnitude 1462 is considered to a run movement speed 1464, which is the maximum base movement speed.

Referring to FIG. 14-2, in some embodiments, the run movement speed 1464 is a discrete value of the movement speed 1460 that is associated with a run movement input 1466 of the movement input magnitude 1462. For example, the movement input magnitude 1462 may be a substantially continuously variable value, which is then associated with a substantially continuously variable movement speed 1460, but the run movement input 1466 may be a discrete and/or separate input (e.g., a button press) that commands the interactive software application to set the base movement speed 1460 to the run movement speed 1464. In some embodiments, the run movement speed 1464 is the maximum movement input magnitude (e.g., 1.0). In some embodiments, the run movement speed 1464 is greater than the maximum movement input magnitude (e.g., 2.0)

In some embodiments, the run movement input 1466 may only be input to and/or received by the interactive software application when the movement input magnitude is at 1.0 (or other maximum). In some embodiments, the run movement input 1466 may be received at any movement input magnitude 1462 (e.g., at any time). In some embodiments, the run movement input 1466 may be received at any movement input magnitude 1462 greater than zero (during any movement). The run movement speed 1464 is still a base movement speed, however, which may be scaled by any scalar value described herein.

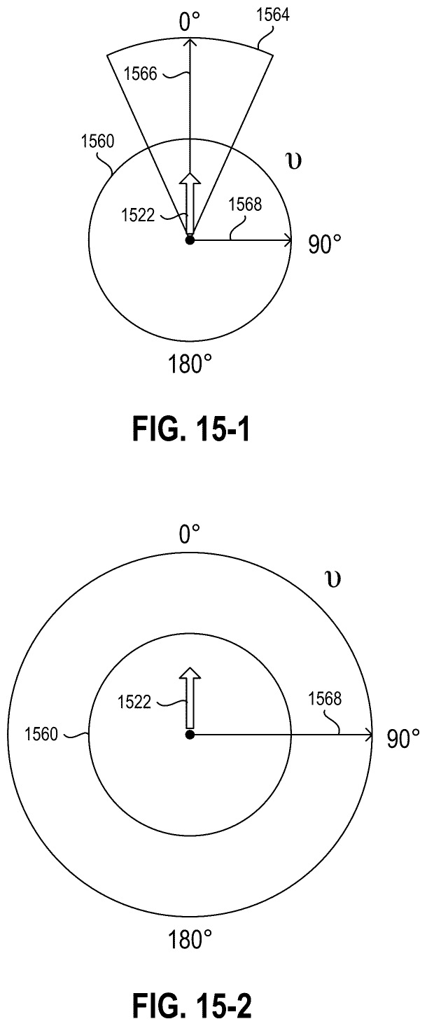

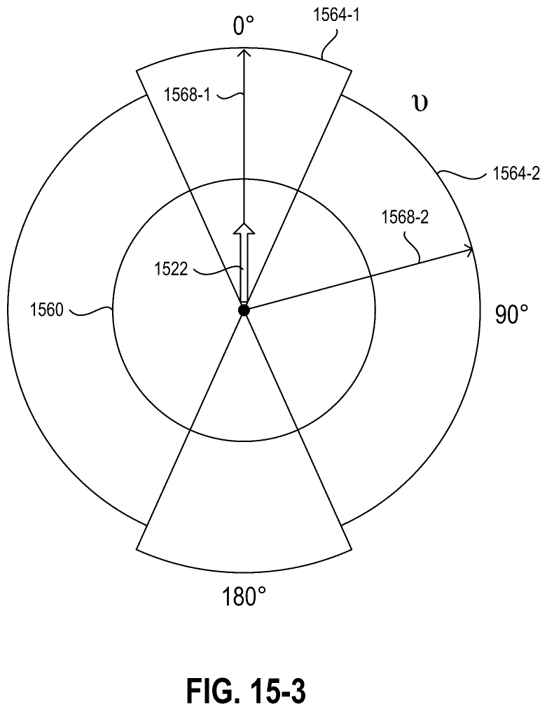

FIG. 15-1 through FIG. 15-3 are graphs illustrating different examples of base movement speeds relative to direction. FIG. 15-1 is a conventional speed graph relative to camera orientation 1522. The base movement speed 1560 is substantially uniform in any movement command direction 1568 for a given movement input magnitude relative to the camera orientation 1522 up to a 1.0 base movement speed 1560. To simulate the character running in the virtual environment, the run movement speed 1564 is available within a forward movement command direction 1568 relative to the camera orientation 1522 in response to a run movement input 1566. However, the run movement speed 1564 is only available in a sector near the forward direction. For example, the avatar model can move in the virtual environment at the run movement speed 1564 when moving in the direction the virtual camera is facing. As described herein, in a standing posture, the model orientation is limited in the angular displacement from the camera orientation. The resulting speed graph allows the avatar to move in any direction while only allowing the avatar to “run” forward.

Referring now to FIG. 15-2, in some embodiments according to the present disclosure, the run movement speed 1564 is available in all directions relative to the camera orientation 1522. For example, the base movement speed 1560 may be available up to a 1.0 base movement speed 1560 in any direction to simulate walking or jogging in any direction. Upon input of a run movement input 1566, the run movement speed 1564 is selected irrespective of the movement command direction 1568 relative to the camera orientation 1522. In some embodiments, equal run movement speed in all directions relative to the camera orientation 1522 may be physically unrealistic for the simulation but provide consistency and predictability for movement in a virtual environment. For competitive environments such as electronic sports (eSports), such consistency and predictability for movement is desirable.

In some embodiments, a hybrid speed graph such as illustrated in FIG. 15-3 allows run movement speed 1564-1, 1564-2 in all movement command directions 1568-1, 1568-2 relative to a camera orientation 1522 with different nominal values for the run movement speed 1564-1, 1564-2 in different sectors of the speed graph. In some embodiments, a base movement speed 1560 is uniform in all movement command directions 1568-1, 1568-2 relative to a camera orientation 1522. The run movement speeds 1564-1, 1564-2 are different for different sectors of the speed graph. For example, a first sector allows a first run movement speed 1564-1 in a forward movement command direction 1568-1. A second sector allows a second run movement speed 1564-2 (less than the first run movement speed 1564-1) in a lateral movement command direction 1568-2. In some embodiments, the run movement speed is mirrored left-to-right and mirrored forward-to-backward. In some embodiments, additional sectors provide different run movement speeds with additional granularity.

FIG. 16-1 through FIG. 16-4 are scalar graphs illustrating different examples of scalar values for scaling a base movement speed (including a run movement speed) relative to different directions. In some embodiments, the speed graphs and scalar graphs described herein are sectored graphs, such as those described in relation to FIG. 15-1 through 15-3 where the movement speeds (base movement speed, run movement speed, etc.) change discontinuously between sectors. In some embodiments, the graphs are non-sectored and the movement speeds varying substantially continuously.

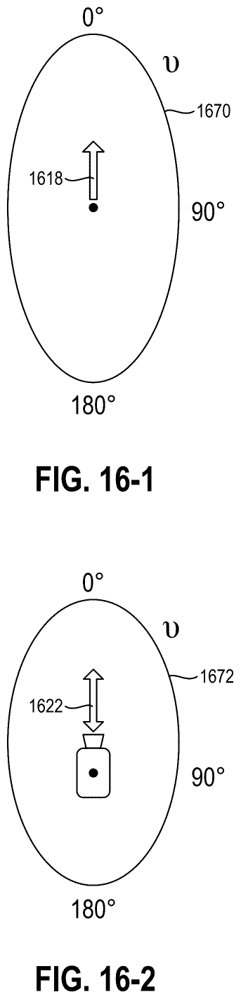

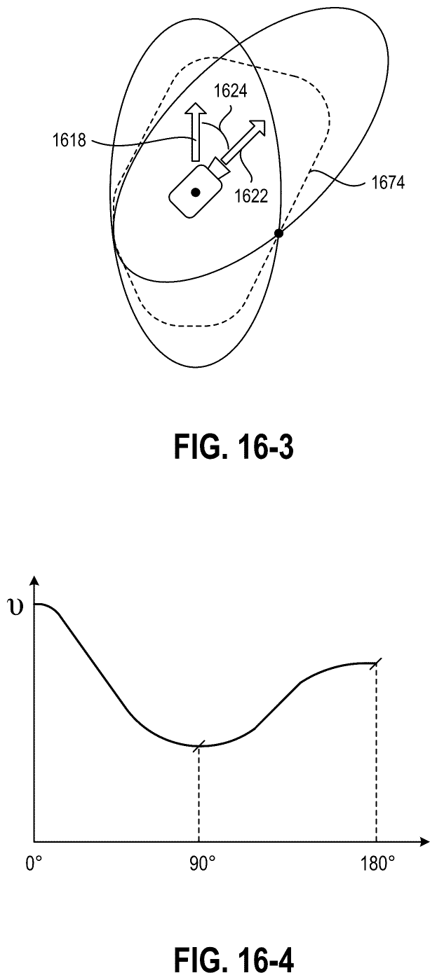

FIG. 16-1 is a non-sectored speed graph of a model scalar 1670 used, in some embodiments, to scale a movement speed based on the movement command direction relative to model orientation 1618. For example, a movement of the avatar model in a forward direction) (0° or backward direction) (180° relative to the model orientation 1618 will result in a greater value of the model scalar 1670 than a lateral movement) (90° relative to the model orientation 1618. The end result is a model scalar value that simulates a character moving faster while running forward and backward than while strafing.

FIG. 16-2 is a non-sectored speed graph of a camera scalar 1672 used, in some embodiments, to scale a movement speed based on the movement command direction relative to camera orientation 1622. For example, a movement of the avatar model in a forward direction) (0° relative to the camera orientation 1622 will result in a greater value of the camera scalar 1672 than a lateral movement) (90° or backward movement (180°) relative to the camera orientation 1622. The result is a camera scalar value that simulates a character moving faster while running in the direction they are facing than while running laterally to or away from the direction they are facing.

FIG. 16-3 is a non-sectored speed graph combining the model scalar graph of FIG. 16-1 and the camera scalar graph of FIG. 16-2. The hybrid scalar is, in some embodiments, used to scale a movement speed based on the movement command direction relative to model orientation 1618 and camera orientation 1622. In some embodiments, the command movement direction is in a forward direction relative to the camera orientation 1622 but a lateral direction for the model orientation 1618. In some embodiments, the model scalar and the camera scalar are averaged to produce a hybrid scalar 1674. In some embodiments, the model scalar and the camera scalar are summed to produce a hybrid scalar 1674.

As will be understood from the hybrid speed graph, the movement speed of the avatar may be scaled at least partially based on an angular displacement 1624 between the model orientation 1618 and the camera orientation 1622. For example, when the model orientation 1618 and the camera orientation 1622 are aligned, the resulting scalar is greater than when the model orientation 1618 and the camera orientation 1622 are misaligned.

In some embodiments, a displacement scalar is calculated based on the angular displacement 1624. For example, FIG. 16-4 is a graph of a displacement scalar and the effect on movement speed based on the angular displacement 1624. The movement speed is greatest when the angular displacement 1624 is close to 0° (e.g., the model orientation 1618 and the camera orientation 1622 are aligned) and less when the angular displacement is close to 180° (e.g., the model orientation 1618 and the camera orientation 1622 are opposite one another such as in a supine posture). The movement speed is least when the model orientation 1618 and the camera orientation 1622 are orthogonal to one another at 90°. As described herein, when in a standing posture, the camera orientation and the model orientation may not exhibit a large angular displacement (e.g., greater than) 45°, while a supine posture may exhibit angular displacements greater than 45° and/or greater than 90°.

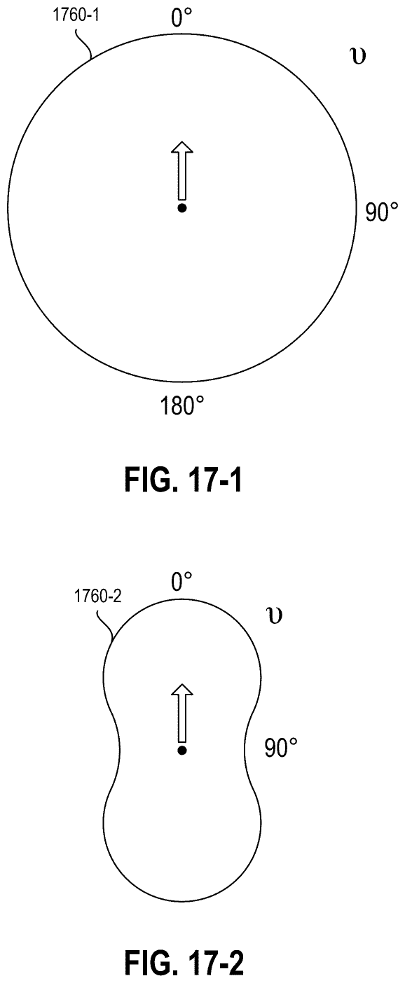

In some embodiments, the base movement speed changes between postures. For example, FIG. 17-1 is a speed graph of a first base movement speed 1760-1 in a first posture (e.g., standing posture). The first base movement speed 1760-1 is substantially uniform in all directions of movement. FIG. 17-2 is a speed graph of a second base movement speed 1760-2 in a second posture (e.g., a supine posture). The second base movement speed 1760-2 changes depending on the direction of movement relative to the camera orientation and/or model orientation. The second base movement speed 1760-2 simulates a faster base movement speed when moving forward and backward relative to the model orientation and/or camera orientation and moving more slowly while strafing laterally.

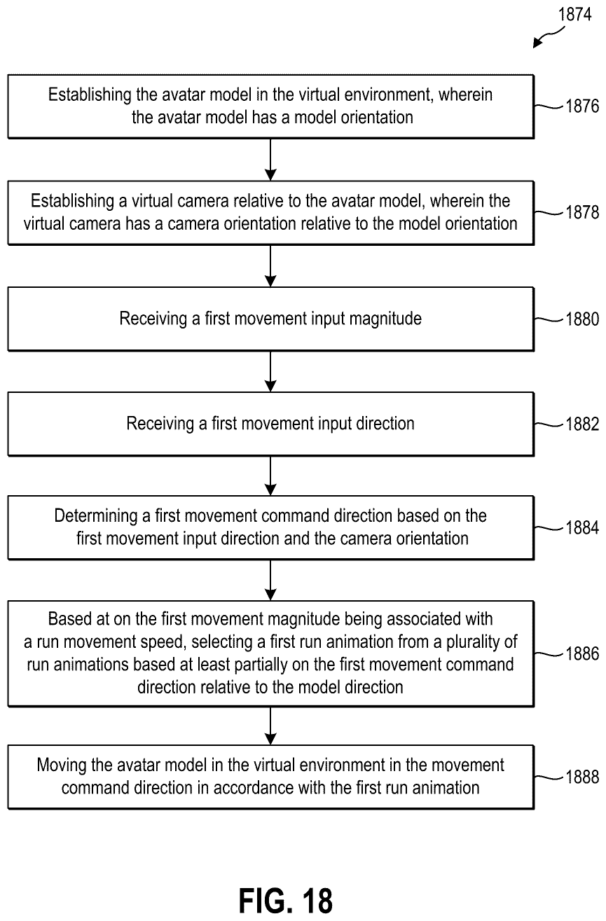

As described above, in some embodiments according to the present disclosure, run movement speeds are available in more directions than only a forward direction. As such, the avatar model is animated differently for run animations in different directions. For example, the run animation for different directions may change based at least partially on direction and movement speed. FIG. 18 is a flowchart illustrating a method 1874 of moving an avatar with a run animation (and movement speed). In some embodiments, the method 1874 includes establishing an avatar model in the virtual environment with a model orientation at 1876 and establishing a virtual camera relative to the avatar model with a camera orientation at 1878. Establishing the avatar model and virtual camera may include any methods or portions of methods described herein.

The method 1874 further includes, in some embodiments, receiving a first movement input magnitude at 1880 and receiving a first movement input direction at 1882. As described herein, the first movement input magnitude and first movement input direction may be received from the same user input device, different user input devices, simultaneously, or not simultaneously.

In some embodiments, the method 1874 includes determining a first movement command direction based on the first movement input direction and the camera orientation at 1884. When the first movement input magnitude is not a run command input or otherwise associated with a run movement speed, a walk animation is selected. Based on the first movement input magnitude being associated with a run movement speed, the method 1874 includes selecting a first run animation from a plurality of run animations based at least partially on the first movement command direction relative to the model direction at 1886. For example, the plurality of run animations may be obtained from a memory storage device of the computing device performing the method, executing the avatar model in the virtual environment, and/or rendering at least one frame of the virtual environment. In some embodiments, the avatar model moves in the virtual environment in the movement command direction in accordance with the first run animation at 1888.

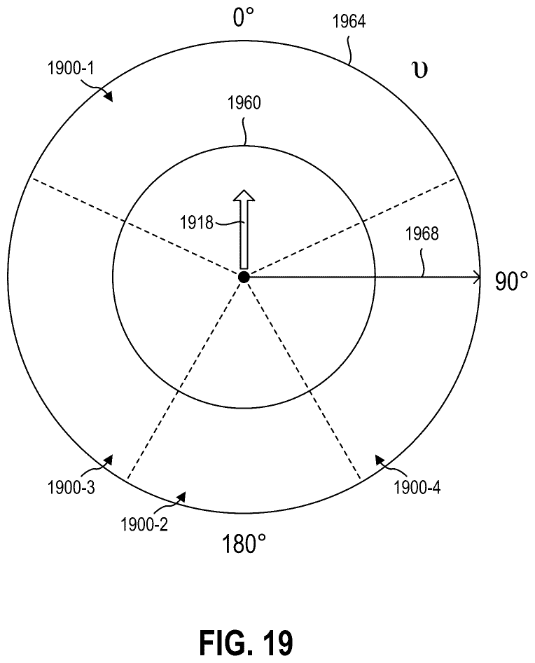

In some embodiments, the movement command direction changes while the avatar model is moving at the run movement speed and/or according to the first run animation. FIG. 19 is a movement chart that illustrates movement speeds 1960, 1964 and animation sectors 1990-1, 1990-2, 1990-3, 1990-4 associated with different run animations relative to model orientation 1918 and a movement command direction 1968. For example, the movement chart is relative to the model orientation 1918. In some embodiments, a first animation sector 1990-1 for a run movement speed 1964 includes a forward command movement direction) (0° relative to the model orientation 1918. In some embodiments, a second animation sector 1990-2 for a run movement speed 1964 includes a backward command movement direction) (180° relative to the model orientation 1918. In some embodiments, a third animation sector 1990-3 for a run movement speed 1964 includes a leftward command movement direction (90° left) relative to the model orientation 1918. In some embodiments, a fourth animation sector 1990-4 for a run movement speed 1964 includes a rightward command movement direction 1968 (90° right) relative to the model orientation 1918. In some embodiments, the animation sectors 1990-1, 1990-2, 1990-3, 1990-4 are equal angular sectors of the movement graph. In some embodiments, the animation sectors 1990-1, 1990-2, 1990-3, 1990-4 have different arcuate lengths in the movement graph. In some embodiments, each animation sector 1990-1, 1990-2, 1990-3, 1990-4 is associated with a different run animation.

When the command movement direction 1968 changes animation sectors the run animation may change. A second run animation is selected from the plurality of run animations, and the first run animation is blended into the second run animation. In some embodiments, blending the first run animation to the second run animation includes matching at least one lock point of the avatar model in the first run animation to the second run animation.

In some embodiments, the movement command direction changing animation sectors and blending the first run animation to the second run animation includes the movement command direction moving from a first animation sector to an angularly adjacent animation sector (e.g., the first animation sector 1990-1 to the third animation sector 1990-3 or the fourth animation sector 1990-4). In some embodiments, the movement command direction changing animation sectors and blending the first run animation to the second run animation includes the movement command direction moving from a first animation sector to an angularly non-adjacent animation sector without the movement command direction being neutral therebetween (e.g., the first animation sector 1990-1 to the second animation sector 1990-2). For example, some user input devices may provide instantaneous changes between directional inputs, such as a keyboard or another user input device capable of simultaneous opposing cardinal direction (SOCD) inputs. In some embodiments, SOCD inputs allow the avatar model to continue in a run animation between angularly non-adjacent animation sectors. In some embodiments, changing from a first animation sector to an angularly non-adjacent animation sector causes the first run animation to stop and a second run animation to be selected and applied to animate the avatar model.

In some embodiments, at least a portion of any method described herein is performed by a computing device including a processor and a hardware storage device. The hardware storage device has instructions stored thereon that, when executed by the processor, cause the computing device to perform at least a portion of an embodiment of a method described herein. In some embodiments, the computing device performs an entire method described herein. In some embodiments, at least a portion of the method is performed at a remote computing device that is not located locally to the computing device. For example, the remote computing device may be a server computer or other remote computing device that is in data communication with the mobile computing device via a network.

In some embodiments, the hardware storage device(s) is a non-transient storage device including any of RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

It should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, to the extent such features are not described as being mutually exclusive. Numbers, percentages, ratios, or other values stated herein are intended to include that value, and also other values that are “about”, “substantially”, or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims. The described embodiments are therefore to be considered as illustrative and not restrictive, and the scope of the disclosure is indicated by the appended claims rather than by the foregoing description.

What is claimed is:

1. A method of animating a virtual camera associated with a virtual character in a video environment, the method comprising:
at a computing device:
establishing a virtual camera at a first location relative to an avatar model of the virtual character, wherein the virtual camera has a camera orientation and the avatar model has a model orientation, wherein the virtual camera is configured to view the virtual environment from a first-person perspective and at a camera height;
obtaining a posture of the avatar model;
obtaining an angular displacement between the camera orientation and the model orientation;
determining a camera height of the virtual camera based on the posture and the angular displacement;
positioning the virtual camera based on the camera height;
rendering a video frame of the virtual environment by the virtual camera at the camera height; and
providing for display the video frame on a display device.

2. The method of claim 1, further comprising displaying the view of the virtual environment on a display device.

3. The method of claim 1, further comprising providing the video frame to a client device.

4. The method of claim 1, wherein obtaining a posture of the avatar model includes selecting a posture from at least a standing posture and a supine posture).

5. The method of claim 1, wherein the model orientation is based at least partially on at least one lock point of the avatar model to a ground of the virtual environment.

6. The method of claim 1, wherein the camera height has a linear relationship to the angular displacement.

7. The method of claim 1, wherein the camera height has a non-linear relationship to the angular displacement.

8. The method of claim 1, wherein the camera height is constant in a first posture for all angular displacements and varies in a second posture for at least one angular displacement.

9. The method of claim 1, wherein the video frame includes a POV model and at least a portion of the model of the virtual character.

10. A method of animating a virtual camera associated with a virtual character in a video environment, the method comprising:
at a computing device:
establishing a virtual camera at a first location of an avatar model of the virtual character, wherein the virtual camera has a camera orientation and the avatar model has a model orientation based at least partially on lock points relative to a ground of the virtual environment;
obtaining a posture of the avatar model;
based on the posture of the avatar model, selecting a range of motion of the camera orientation relative to the model orientation from at least a first range of motion and a second range of motion;
obtaining an angular displacement between the camera orientation and the model orientation;
based at least partially on selecting the first range of motion; not moving at least one lock point of the avatar model relative to the ground based on the angular displacement and the range of motion; and
based at least partially on selecting the second range of motion, moving at least one lock point of the avatar model relative to the ground based on the angular displacement and the range of motion.

11. The method of claim 10, further comprising rolling at least a portion of a POV model relative to the virtual environment based on the posture and the angular displacement.

12. The method of claim 10, wherein the first range of motion is 180° and the second range of motion is less than 180°.

13. The method of claim 12, wherein the posture is selected from a first posture, a second posture, and a third posture, and the first range of motion of is associated with the first posture, the second range of motion is associated with the second posture, and a third range of motion is associated with the third posture.

14. The method of claim 10, wherein the posture is selected from at least a standing posture and a supine posture.

15. The method of claim 14, wherein the standing posture has to two lock points relative to the ground of the virtual environment and the supine posture has at least three lock points relative to the ground of the virtual environment.

16. The method of claim 15, wherein moving at least one lock point of the avatar model based on the angular displacement and the range of motion includes rotating the model orientation toward the camera orientation.

17. The method of claim 10, further comprising rendering a video frame of the virtual environment by the virtual camera.

18. The method of claim 10, further comprising scaling the range of motion based on at least one equipped item of the avatar model.

19. A computing device having instructions stored thereon that, when executed by a processor of a computing device cause the computing device to:
establish a virtual camera at a first location relative to an avatar model of the virtual character, wherein the virtual camera has a camera orientation and the avatar model has a model orientation, wherein the virtual camera is configured to view the virtual environment from a first-person perspective and at a camera height;
obtain a posture of the avatar model;
obtain an angular displacement between the camera orientation and the model orientation;
determine a camera height of the virtual camera based on the posture and the angular displacement;
position the virtual camera based on the camera height;
render a video frame of the virtual environment by the virtual camera at the camera height; and
provide for display the video frame on a display device.

20. The computing device of claim 19, further comprising the display device in data communication with the processor.
